(19) United States
(12) Patent Application Publication
(10) Pub. No.: US 2014/0035357 A1
(43) Pub. Date: Feb. 6, 2014

(54) Battery, Battery Management System, and Method to Control a Battery

(71) Applicants: Michael Hausmann, Gleisdorf (AT); Viktor Kahr, Hart bei Graz (AT)

(72) Inventors: Michael Hausmann, Gleisdorf (AT); Viktor Kahr, Hart bei Graz (AT)

(73) Assignee: INFINEON TECHNOLOGIES AG, Neubiberg (DE)

(21) Appl. No.: 13/564,666

(22) Filed: Aug. 1, 2012

(51) Int. Cl. B60L 1/00; H04B 5/00; H04B 7/00; H02J 1/00; H01M 10/42

(52) U.S. Cl. 307/9.1; 307/43; 429/7; 455/41.2; 455/41.1

(57) ABSTRACT

The invention relates to a battery, a battery management system, and a method to control a battery. According to an embodiment, a system includes a plurality of batteries. Each battery includes an individual associated battery control chip. Advantageously, each battery control chip is mounted within a housing of a respective associated battery. Further, each battery control chip may be adapted for wireless communication.

### TECHNICAL FIELD

The invention generally relates to a battery, a battery management system, and a method to control a battery.

### BACKGROUND

In vehicles with electrical drive chain, e.g., a car comprising an electrical engine (and, optionally, a combustion engine), batteries comprising a plurality of battery cells may be used to provide the energy for the electrical drive chain.

The battery cells, e.g., respective Lithium Ion Cells, or any other kind of cells may be connected in series, so that a so-called battery stack is formed. The series connection of the cells may result in the batteries providing a total voltage of more than ten, preferably more than hundred, two-hundred or five-hundred volts.

As is shown in FIG. 1, to control the batteries, a respective battery management system 7 (BMS) may be used, whereby a respective battery stack 1 may be divided into several segments, so-called battery blocks 4, each comprising a plurality of battery cells 2 (e.g., twelve battery cells).

For each of the battery blocks 4, an associated controlling circuit 5a, 5b, 5c (so-called BMS Satellite) may be provided.

For instance, a first BMS Satellite 5a may be used to monitor and/or control a first battery block 4, a second BMS Satellite 5b may be used to monitor and/or control a second battery block, a third BMS Satellite 5c may be used to monitor and/or control a third battery block, etc., etc.

Each of the BMS Satellites 5a, 5b, 5c may communicate with a central battery control unit 3 (BCU).

For this purpose, each of the BMS Satellites 5a, 5b, 5c via one or several lines/cables may be connected to a respective associated interface 6, and each of the interfaces 6 via a respective bus system (e.g., comprising one or more additional lines/cables) may be connected to the above central battery control unit 3 (BCU).

By the above BMS Satellites 5a, 5b, 5c, e.g., the electric charge loaded in the respective battery block associated with a respective BMS Satellite 5a, 5b, 5c may be detected.

Further, with the help of a respective BMS Satellite 5a, 5b, 5c and/or the central battery control unit 3, an appropriate reaction to a detected electric charge loaded in respective battery blocks may be controlled.

For instance, by use of/under control of a respective BMS Satellite 5a, 5b, 5c, a single associated battery cell, and/or an associated battery block may be discharged (passive balancing). Further, by use of/under control of a respective BMS Satellite 5a, 5b, 5c, charge may be transferred between single battery cells, and/or respective battery blocks (active balancing).

However, in the above interfaces 6, a separation of the respective voltage potentials must be provided for, which is expensive, and fault-prone.

Further, the above cables are difficult to isolate, and relatively heavy.

In addition, the plug connectors for the cables are expensive, and fault-prone, also.

Still further, for the above bus system, a relatively high bandwidth is necessary.

For these or other reasons there is a need for improved batteries, battery management systems, and methods to control a battery.

### BRIEF DESCRIPTION OF THE DRAWINGS

The accompanying drawings are included to provide a further understanding of the present invention and are incorporated in and constitute a part of this specification. The drawings illustrate embodiments of the present invention and together with the description serve to explain the principles of the invention. Other embodiments of the present invention and many of the intended advantages of the present invention will be readily appreciated, as they become better understood by reference to the following detailed description.

FIG. 1 depicts a schematic structure of a conventional battery management system; and

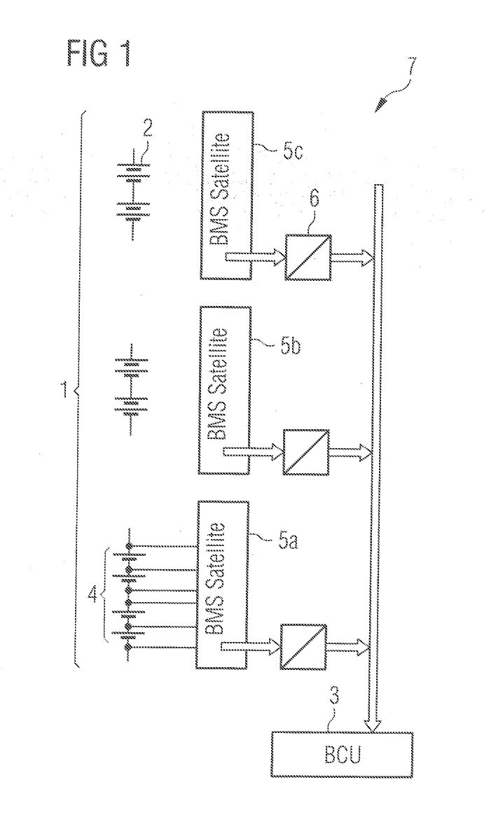

FIG. 2 depicts a schematic structure of an exemplifying battery management system according to an embodiment of the invention.

### DETAILED DESCRIPTION OF ILLUSTRATIVE EMBODIMENTS

In the following detailed description, reference is made to the accompanying drawings, which form a part hereof, and in which is shown by way of illustration specific embodiments in which the invention may be practiced. It is to be understood that other embodiments may be utilized and structural or other changes may be made without departing from the scope of the present invention. The following detailed description, therefore, is not to be taken in a limiting sense, and the scope of the present invention is defined by the appended claims.

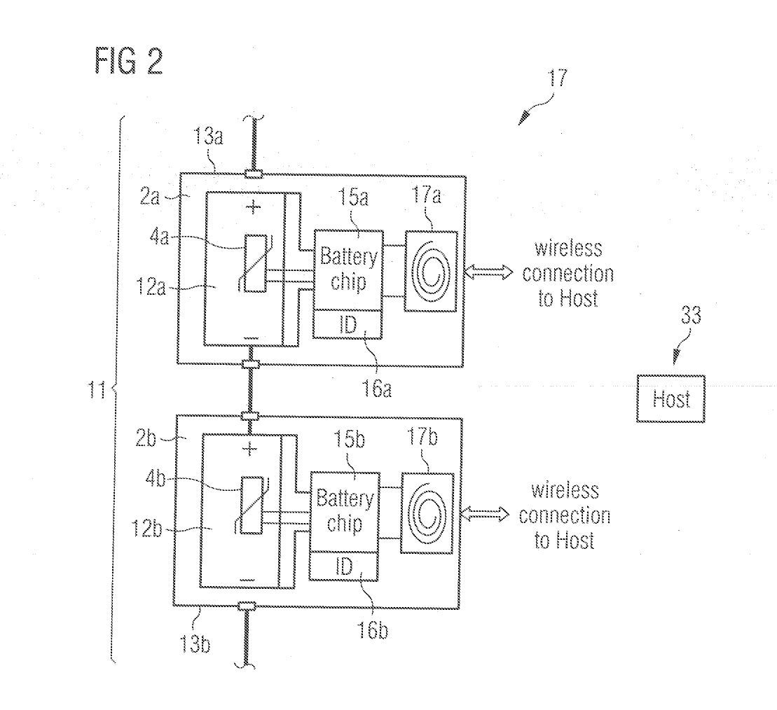

FIG. 2 shows a schematic representation of an exemplifying battery management system 17 according to an embodiment of the invention.

The battery management system 17 may, e.g., be used in a vehicle, e.g., a car, a truck, a bus, a plane, a helicopter, a motorcycle, a train, etc.

In particular, the battery management system 17 may be used in a vehicle with electrical drive chain, for instance, in a vehicle comprising an electrical engine (and/or, optionally, a combustion engine).

Each comprising a respective battery 12a, 12b may be used, for example, to provide the energy for the electrical drive chain, a plurality of battery cells 2a, 2b.

As is shown in FIG. 2, the battery cells 2a, 2b may be connected in series, so that a respective battery stack 11 is formed.

As battery cells 2a, 2b, e.g., respective Lithium Ion cells, or any other kind of rechargeable cells may be used, such as, e.g., NiZn Cells, NiMH cells, NiCd cells, Lead-acid cells, etc.

The series connection of the battery cells 2a, 2b may result in the batteries 12a, 12b in common provide a total voltage of more than ten, preferably more than hundred, two-hundred or five-hundred volts.

For instance, each of the cells may provide a voltage of between e.g., 1 V and 6 V, for instance, between 1 V (or 2 V) and 4 V, e.g., about between 3 V and 4 V, etc.

The number of battery cells 2a, 2b connected in series may be relatively high. For instance, more than three, ten, fifty or hundred battery cells 2a, 2b may be connected in series.

Preferably, as is shown in FIG. 2, to control the batteries, other than in conventional systems, the battery stack 11 may not be divided into several segments/battery blocks, each comprising a plurality of battery cells, and each being associated with one single controlling circuit/BMS Satellite.

Instead, in the battery management system 17 shown in FIG. 2, for each of the above battery cells 2a, 2b/batteries 12a, 12b of the battery stack 11, an individual battery controlling integrated circuit/battery control chip 15a, 15b is provided. In other words, the number of battery control chips 15a, 15b may correspond or substantially correspond to the number of battery cells 2a, 2b in the system.

As is shown in FIG. 2, the battery cells 2a, 2b may each comprise a negative electrode, a positive electrode, and, e.g., a respective electrolyte. Optionally, the battery cells 2a, 2b may comprise additional components, such as, e.g., a separator, etc. Further, the battery cells 2a, 2b comprise a housing 13a, 13b encapsulating the electrodes, and, e.g., the electrolyte and/or separator, etc.

The negative electrode, e.g., in the case of Lithium Ion cells, may, e.g., be made from Carbon, or any other suitable material, and the positive electrode, e.g., from a respective metal oxide, or any other suitable material. Further, the electrolyte may, e.g., be a lithium salt in a respective organic solvent, or any other suitable material. As already mentioned above, instead of Lithium Ion cells, other, different battery cells may also be used, e.g., respective Na- or Mg-based battery cells (constructed similar as Lithium Ion cells), NiMH cells, NiCd cells, etc. For example, in the case of NiCd cells, the positive electrode may, e.g., be made from nickel oxide-hydroxide, or any other suitable material, the negative electrode may, e.g., be made from metallic cadmium, or any other suitable material, and the electrolyte may, e.g., be a respective alkaline electrolyte, e.g., potassium hydroxide, etc. Still further, e.g., in the case of NiMH cells, the positive electrode may, e.g., be made from nickel oxide-hydroxide, the negative electrode may, e.g., be made from a respective hydrogen-absorbing alloy, e.g., a respective intermetallic compound, for instance comprising rare earthes and/or, e.g., Nickel and/or Cobalt and/or Manganese and/or Aluminum, etc., or any other suitable material, and the electrolyte may e.g., be a respective alkaline electrolyte, such as, e.g., potassium hydroxide, etc.

The housing 13a, 13b encapsulating the electrodes, and, e.g., the electrolyte etc. may e.g., be made from plastic, e.g., a respective hard or semi-hard plastic. Alternatively, the housing may e.g., be made from any other suitable material, for instance, may be metallic (and/or may e.g., be made from the same material, as the negative (or positive) electrode). Further, the housing 13a, 13b may e.g., be cylindrical, prismatic, and may or may not comprise threaded terminals.

As is shown in FIG. 2, the above battery controlling integrated circuits/battery control chips 15a, 15b—other than with conventional systems—may be mounted within the housing 13a, 13b, i.e., may be a fixed part of a respective associated battery cell 2a, 2b.

By the above battery control chips 15a, 15b, the electric charge loaded in a respective associated battery cell 2a, 2b may be detected.

For this purpose, for instance, the battery control chip 15a, e.g., by use of respective lines connected therewith, and with, e.g., the positive and/or negative electrode, and/or the electrolyte within the battery 12a may measure the voltage of the associated battery cell 2a. Further, the battery control chip 15b, e.g., by use of respective lines connected therewith, and with, e.g., the positive and/or negative electrode, and/or the electrolyte within the battery 12b may measure the voltage of the associated battery cell 2b, etc.

Alternatively or additionally, the battery control chips 15a, 15b may be connected with a respective temperature sensor 4a, 4b within a respective battery 12a, 12b. Hence, by the above battery control chips 15a, 15b, the temperature of a respective associated battery cell 2a, 2b may be detected. Alternatively or additionally, any other kinds of additional values may be measured/detected by the battery control chips 15a, 15b, preferably, but not limited to, e.g., values not detectable from outside the battery 12a, 12b, such as, for instance, the gas pressure inside the battery 12a, 12b, and/or the gas composition inside the battery 12a, 12b, and/or values characterizing the state of the coating of the electrodes (e.g., with regards the numbers of ions) (e.g., based on respective spectroscopic processes, etc.). Based on one or several of these additional values, the charge loaded in a battery cell 2a, 2b may also be detected, making the above voltage measurement superfluous.

The battery control chips 15a, 15b may e.g., carry out the above voltage measurement and/or temperature detection and/or detection of the above additional values, etc. in regular periods of time, and/or after receiving respective control signals from a central host/control unit 33, e.g., a respective central battery control unit, or any other central control unit (see explanations below).

The results of various voltage measurements and/or temperature detections and/or detections of the above additional values may be stored in a respective storage on a respective battery control chip 15a, 15b, such that in addition to the current voltage, the current temperature, etc., the history of the measured voltages/temperatures/additional values is detectable.

As is further shown in FIG. 2, on each battery control chip 15a, 15b, a respective unique serial number 16a, 16b/identification number (ID) may be stored (e.g., in the above, or in an additional storage).

Hence, the ID stored on the battery control chip 15a may be different from the ID stored on the battery control chip 15b, and from the IDs of all the other battery control chips of the system 17. Likewise, the ID stored on the battery control chip 15b may also be different from the IDs of all the other battery control chips of the system 17, etc. Optionally, the IDs stored on the battery control chips of the system 17 may additionally be different from IDs stored on battery control chips similar to the battery control chips used in the system 17, but used in other systems (or not yet used in the system 17).

As is further shown in FIG. 2, each of the battery control chips 15a, 15b of the system 17 may communicate with the above central host/control unit 33.

Other than in conventional systems, for this purpose, e.g., a respective wireless connection may be used between the central host/control unit 33 and a respective battery control chip 15a, 15b. To establish the wireless connection, each battery control chip 15a, 15b via respective lines may be connected with a respective wireless transceiver 17a, 17b. The wireless transceivers 17a, 17b may e.g., be mounted within the housing 13a, 13b, i.e., may be a fixed part of a respective associated battery cell 2a, 2b, or, alternatively, may be mounted outside the housing. Further, alternatively, the wireless transceivers may be integral part of a respective battery control chip 15a, 15b. To enable the wireless connection, the above housing 13a, 13b may be provided with one or several windows, so as to enable a break through the Faraday cage otherwise provided by the housing 13a, 13b.

The wireless connection between the central host/control unit 33, and a respective battery control chip 15a, 15b may e.g., be a WLAN (Wireless Local Area Network) connection, or e.g., an NFC (Near field communication) connection, or any other suitable wireless connection. Instead of a wireless connection, alternatively, any other kind of connection, e.g., a wire-based connection between the central host/control unit 33, and a respective battery control chip 15a, 15b may also be used. For instance, the above (positive and/or negative) terminals of the battery cells may be used to establish respective wire-based connections between the battery control chips 15a, 15b and the central host/control unit 33, whereby e.g., upon respective (ordinary) power lines connected with the battery terminals a respective HF-signal carrying the data to be transmitted to/from the central host/control unit 33 is modulated.

To wirelessly or non-wirelessly address a selected one of the battery control chips 15a, 15 via a respective wireless connection, the ID associated with the addressed battery control chip 15a, 15b may be used, or any other suitable address of the respective battery control chip 15a, 15b within the system 17.

Via the above wireless or wired connections, e.g., by sending out respective wireless or non-wireless control signals, the central host/control unit 33 as mentioned above e.g., may trigger the above voltage measurements and/or temperature detections and/or detection of the above additional values carried out by the battery control chips 15a, 15b.

Alternatively or additionally, via the above wireless or wired connections, the central host/control unit 33 may e.g., read out the above storage/additional storage of the battery control chips 15a, 15b. For this purpose, also, respective wireless or non-wireless control signals may be sent from the central host/control unit 33 to the above battery control chips 15a, 15b. In return, via wire or wirelessly, e.g., the current temperature and/or voltage and/or additional detected value of a respective battery cell 2a, 2b, and/or the results of various older voltage measurements and/or temperature detections and/or detections of additional values (i.e., the history of the measured voltages/temperatures/additional values) stored in the above storage may be transmitted from a respective battery control chip 15a, 15b to the above central host/control unit 33. Additionally or alternatively, wirelessly or non-wirelessly, e.g., the above ID stored in the above additional storage may be transmitted from a respective battery control chip 15a, 15b to the above central host/control unit 33, etc. Hence, should one of the batteries 12a, 12b/battery cells 2a, 2b of the system 17 be replaced by a new battery/battery cell with a new/different ID, this may be instantly detected by the central host/control unit 33.

By use of the battery control chips 15a, 15b, and/or the central control unit 33 wirelessly or non-wirelessly connected to the battery control chips 15a, 15b of the system 17, an appropriate reaction to a detected temperature/temperature history of the battery cells 2a, 2b, and/or a detected electric charge/history of the electric charge loaded in the battery cells 2a, 2b, and/or a detected additional value/history of detected additional values may be controlled.

For instance, by use of a respective battery control chip 15a, 15b (alone, or e.g., triggered by respective wireless or wired control signals sent by the central host/control unit 33 to the respective battery control chip 15a, 15b), a respective selected single battery cell 2a, 2b associated with the respective battery control chip 15a, 15b may be discharged (passive balancing). For this purpose, the respective battery control chip 15a, 15b may e.g., initiate a bypass of at least a part of the respective battery current.

Further, by use of/under control of the battery control chips 15a, 15b (also e.g., triggered by respective wireless or wired control signals sent by the central host/control unit 33 to the battery control chips 15a, 15b), charge may be transferred between different ones of the above battery cells 2a, 2b, e.g., from the battery cell 2a to the battery cell 2b, or vice versa (active balancing).

As becomes clear from the explanations above, in the above system 17, it may be relatively easy to exchange one of the batteries 12a, 12b/battery cell 2a, 2b against a new battery/battery cell. For instance, during an exchange of batteries, a service switch in the high current path may be opened without problems, no specific protection of a battery control chip 15a, 15b against cross currents may be necessary, etc., etc. Further, even when batteries 12a, 12b/battery cells 2a, 2b are exchanged, the accuracy of the system 17 may be maintained, as each battery 12a, 12b/battery cell 2a, 2b may be trimmed/calibrated individually (e.g., during after production), and the respective calibration data may be stored on a respective, associated chip 15a, 15b.

Further, as the history of the voltages/temperatures/additional values measured/detected for a respective battery 12a, 12b/battery cell 2a, 2b may be stored on one single associated battery control chip 15a, 15b, and as the respective battery control chip 15a, 15b and the associated battery/battery cell may form a unity not easily to be broken apart, an individual, safe “Datalog” for each single battery 12a, 12b/battery cell 2a, 2b is achieved, enhancing the overall security of the system 17, and limiting the risk of fraud. Further, by use of the chips 15a, 15b, pre-processing of the above data stored on the chips 15a, 15b (referring, e.g., to the detected voltages/temperatures/additional values, and/or the history of the voltages/temperatures/additional values, etc.) is possible. For instance, by use of the above chips 15a, 15b, e.g., based on the detected charge loaded in the respective battery cell 2a, 2b in the cell's lifetime (e.g., first, 100%, then, e.g., 20%, then, e.g., 80%, then, e.g., 30%, then, e.g., 90%, etc., etc.), a corresponding number of full charge/full discharge cycles may be calculated. Thereby, e.g., the above detected discharge states in the lifetime of the battery cell 2a, 2b (100%, 20%, 80%, 30%, 90%, etc., etc.) may e.g., be converted into the corresponding number of full charge (100%)/full discharge (0%) cycles, reflecting the “chemical age” of the battery cell 2a, 2b. The above or any other pre-processing carried out by the chips 15a, 15b may e.g., be based on respective SoC-models of the respective battery stored on a respective associated chip 15a, 15b, and e.g., reflecting the chemistry of the respective battery. By the pre-processing of data, the amount of data to be communicated between a respective chip 15a, 15b, and the central host/control unit 33 may be reduced.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention is only limited by the claims and the equivalents thereof.

What is claimed is:

1. A system, comprising:
a plurality of batteries; and
a plurality of battery control chips, each battery associated with an individual battery control chip.

2. The system of claim 1, wherein each battery control chip is mounted within a housing of the associated battery.

3. The system of claim 1, wherein each battery control chip is configured for wireless communication.

4. The system of claim 3, further comprising a central control unit operationally coupled with the battery control chips.

5. The system of claim 4, wherein the central control unit is operationally coupled for wireless communication with each of the battery control chips.

6. The system of claim 1, wherein each battery control chip is configured to measure a temperature of the associated battery.

7. The system of claim 6, wherein each battery control chip comprising a storage for storing a history of the measured temperatures of the respective associated battery.

8. The system of claim 7, each battery control chip comprising a storage for storing a history of the detected electric charge loaded in the respective associated battery, and/or a history of the detected additional values.

9. The system of claim 1, wherein each battery control chip is configured to detect an electric charge loaded in a respective associated battery.

10. The system of claim 1, wherein each battery control chip is configured to detect a gas pressure and/or a gas composition and/or a value characterizing the state of an electrode coating.

11. The system of claim 1, wherein each battery control chip comprises a storage for storing an individual battery control chip ID.

12. A vehicle comprising:
a plurality of battery cells;
a plurality of battery control chips, each battery cell associated with an individual battery control chip; and
an electrical drive chain powered by the battery cells.

13. The vehicle of claim 12, wherein the battery cells are connected in series.

14. The vehicle of claim 13, wherein the battery cells together are configured to provide a voltage of more than one hundred volts.

15. The vehicle of claim 14, further comprising a control unit configured to wirelessly communicate with each of the individual control chips.

16. The vehicle of claim 12, wherein the vehicle comprises a car, a truck, a bus, a plane, a helicopter, a motorcycle, or a train.

17. A method to control a battery, the method comprising:
wirelessly communicating between a battery control chip associated with the battery, and a central control unit.

18. The method of claim 17, wherein wirelessly communicating comprises communicating via a wireless local area network connection.

19. The method of claim 17, wherein wirelessly communicating comprises communicating via a near field communication connection.

20. The method of claim 17, wherein the battery control chip is mounted within a housing of the associated battery.

21. A battery unit, comprising:
a battery cell;
a battery control chip; and
means for wirelessly communicating with a control unit.

22. The battery of claim 21, wherein the means for wirelessly communicating is mounted within a housing of the battery unit.

23. The battery of claim 21, wherein the means for wirelessly communicating comprises means for communicating via a wireless local area network connection.

24. The battery of claim 21, wherein the means for wirelessly communicating comprises means for communicating via a near field communication connection.
